(19) United States
(12) Patent Application Publication
(10) Pub. No.: US 2007/0179043 A1
(43) Pub. Date: Aug. 2, 2007

(54) Catalyst body, inorganic support, and method of producing inorganic support

(75) Inventor: Kunihiro Kojima, Chiryu-shi (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/701,894

(22) Filed: Feb. 2, 2007

(30) Foreign Application Priority Data
Feb. 2, 2006 (JP) 2006-025583

(51) Int. Cl. B01J 29/04

(52) U.S. Cl. 502/60; 502/439; 502/64

(57) ABSTRACT

A catalyst body is composed of a porous support made mainly of cordierite. Single crystals of at least one kind of zeolite such as silicalite are formed directly on the surface of the porous support. Al₂O₃, SiO₂ are component elements forming the porous support and used as a seed crystal for growing the single crystals of zeolite on the surface of the porous support. Further, the catalyst made of noble metal such as Pt is supported on the single crystals of zeolite.

### CROSS-REFERENCE TO RELATED APPLICATIONS

This application is related to and claims priority from Japanese Patent Application No. 2006-25583 filed on Feb. 2, 2006, the contents of which are hereby incorporated by reference.

### BACKGROUND OF THE INVENTION

1. Field of the Invention

The present invention relates to an inorganic support having a cordierite monolith base as a porous support, on the surface of which single crystals of zeolite are directly grown, further relates to a catalyst body having the inorganic support and a catalyst, and still further relates to a method of producing such an inorganic support applicable to various applications such as automobile exhaust gas purifying, fuel cell, and environmental purifying.

2. Description of the Related Art

There is a catalyst body capable of purifying automobile exhaust gas emitted from an internal combustion engine such as a diesel engine mounted on a diesel vehicle. Such a catalyst body is composed of a porous support made mainly of cordierite and a noble metal as a catalyst formed on the surface of the porous support. However, because a bonding force between the cordierite and the catalyst is generally weak, the porous support material does not adequately support a necessary amount of the catalyst on the surface thereof. In order to avoid such a conventional drawback, namely, to enhance the weak bonding force between them, a conventional technique provides an improved inorganic support capable of supporting oxide particles such as γ-alumina (Al₂O₃) having a highly specific surface area of approximately 10 μm thick on the surface thereof. Because of having a large area thereof, γ-alumina (Al₂O₃) has a large physical adsorption capability. For example, Japanese patent laid open publication No. JP H5-31359 has disclosed such a conventional technique.

Although the γ-alumina (Al₂O₃) supports the catalyst thereon, the intrinsic nature of γ-alumina (Al₂O₃) causes it to be an inadequate catalyst, this is because a diffusion speed of reaction gas is relatively low in the inside area of the porous support. In addition, because of a low heat resistance capability, the shape of the γ-alumina (Al₂O₃) is deformed, and the catalyst is thereby embedded in the particles of γ-alumina (Al₂O₃). Accordingly, the catalyst cannot be activated adequately. Thus, the conventional technique has a drawback of requiring excess amount of catalyst on the surface of the γ-Alumina (Al₂O₃) in order to achieve a practical purifying capability to sufficiently purify exhaust gas.

In addition, because a layer made of γ-alumina (Al₂O₃) becomes a resistance against the flow of exhaust gas, the output of an internal combustion engine is decreased, and further because of increasing a heat capacity of the catalyst body and of decreasing the temperature rise of the catalyst body, it takes a long time period counted from an engine start-up to its activation state.

In addition to the conventional drawbacks described above, a large amount of unburned fuel such as hydro carbon (HC) is exhausted from an internal combustion engine into atmosphere at engine start-up, and in particular, a large amount of particulate matters (PM) such as hydro carbon (HC), carbon oxide (CO), nitrogen oxide (NOx), and so forth involved in exhaust gas emitted from a diesel engine are exhausted and suspended in atmosphere.

Still further, catalyst particles are embedded into γ-alumina (Al₂O₃) after the catalyst body is used at approximately 1000° C. for a long period of time, and the catalyst particles are sintered by thermal energy. Because of moving and combining the catalyst particles to each other caused by the thermal energy, the effective activation surface area of the catalyst particles thereby deteriorate. Further, this decreases the purifying capability of the catalyst body. This deterioration requires additional catalyst of approximately 1.7 times of the total amount of the catalyst in a new vehicle.

Accordingly, the conventional technique cannot solve the increase of environment load and manufacturing cost.

### SUMMARY OF THE INVENTION

It is an object of the present invention to provide an improved inorganic support, an improved catalyst body using the inorganic support, and a method of the inorganic support. The inorganic support is capable of avoiding sintering of catalyst formed on a surface of a porous support made of inorganic materials and capable of reducing a total amount of the catalyst to be formed on the surface of the porous support.

To achieve the above purposes, in accordance with a first aspect of the present invention, there is provided a catalyst body having a porous support made of inorganic materials, single crystals of at least one kind of zeolite that are grown directly on the surface of the porous support, and catalysts supported on the single crystals of zeolite. A component element forming the porous support is used as a seed crystal of each single crystal of zeolite.

When compared with alumina, each single crystal of zeolite has a superior thermal resistance property and is grown directly on the surface of the porous support. The catalysts are supported on the single crystals of zeolite. This feature of the present invention produces a strong barrier capable of preventing the coupling of the catalyst particles to each other. This configuration of the catalyst body can avoid the occurrence of sintering the catalysts and achieve the reduction of the total amount of the catalysts during the use.

In accordance with a second aspect of the present invention, there is provided an inorganic support having a porous support made of inorganic materials, and single crystals of at least one kind of zeolite directly grown on a surface of the porous support. A component element forming the porous support is used as a seed crystal of each single crystal of zeolite. The inorganic support of the second aspect of the present invention has the same effect of the catalyst body according to the first aspect described above.

In the catalyst body and the inorganic support of the present invention, the porous support is made of cordierite and the single crystals are grown based on Al₂O₃, SiO₃ that are main components of cordierite as a seed crystal. Each single crystal of zeolite has a composition of one or more compounds selected from Al₂O₃, SiO₃, and derivations of Al₂O₃, SiO₃.

In accordance with a third aspect of the present invention, there is provided a method of producing the above inorganic support having steps of immersing a porous support made of inorganic materials into an aqueous solution in which raw materials of zeolite single crystals are mixed, and performing hydrothermal manner for the aqueous solution involving the porous support and the raw materials.

### BRIEF DESCRIPTION OF THE DRAWINGS

A preferred, non-limiting embodiment of the present invention will be described by way of example with reference to the accompanying drawings, in which:

FIG. 1 is a sectional view showing a schematic configuration of a catalyst body according to an embodiment of the present invention;

FIG. 2 is a flow chart showing a method of producing an inorganic support according to the embodiment of the present invention;

FIG. 3 is a flow chart showing a method of producing catalyst to be used for forming the catalyst body of the embodiment according to the present invention; and

FIG. 4 is a flow chart showing a method of producing the catalyst body of the embodiment according to the present invention.

### DETAILED DESCRIPTION OF THE PREFERRED EMBODIMENTS

Hereinafter, various embodiments of the present invention will be described with reference to the accompanying drawings. In the following description of the various embodimWents, like reference characters or numerals designate like or equivalent component parts throughout the several diagrams.

### Embodiment

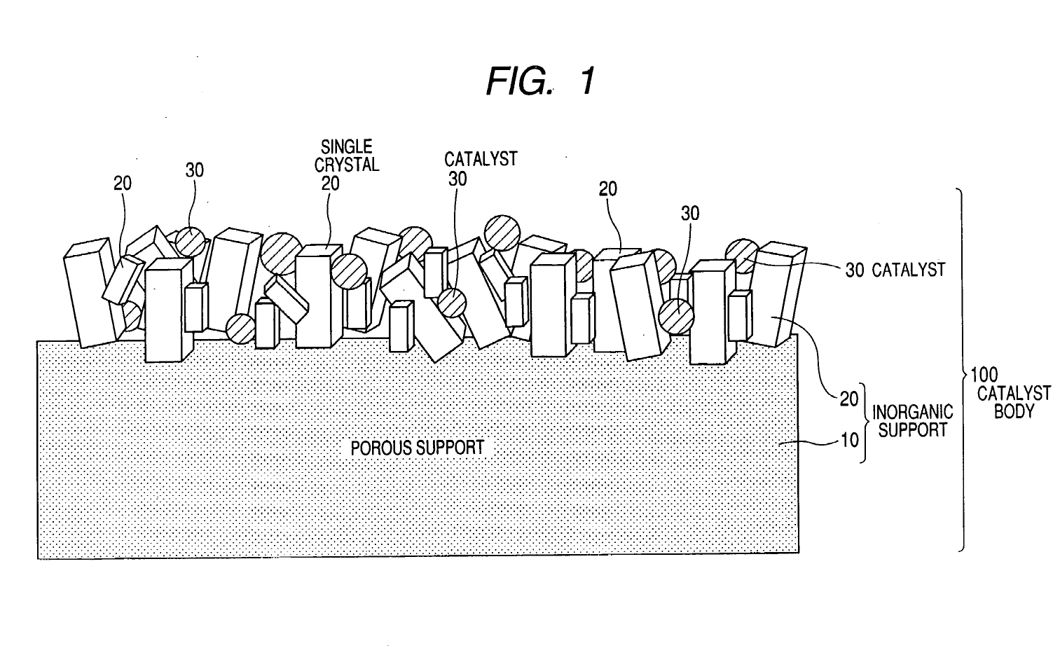

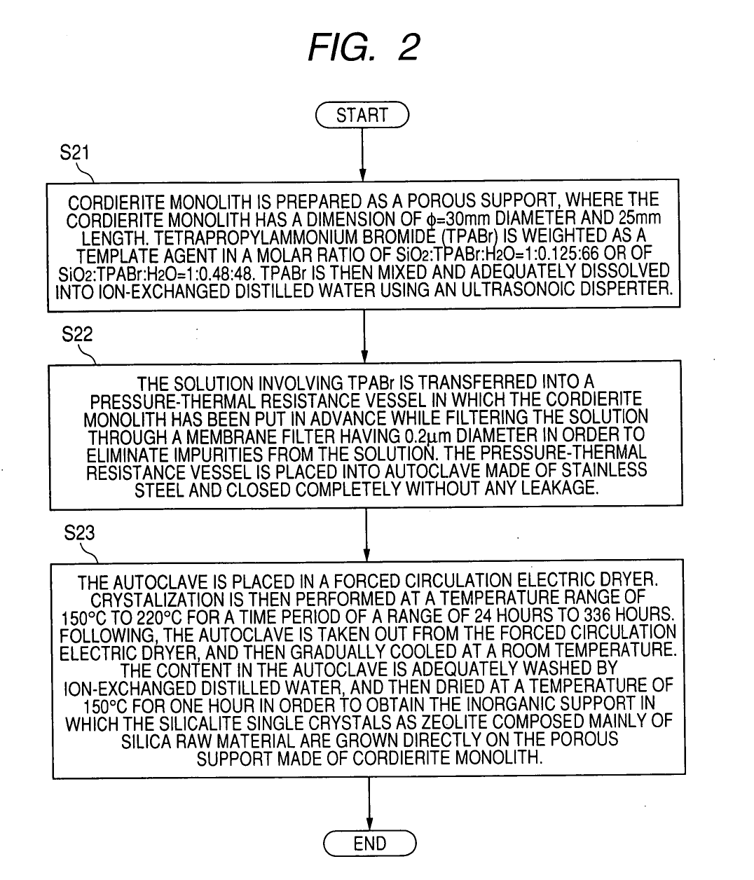

A description will be given of the preferred embodiment of the present invention with reference to FIG. 1 and FIG. 2.

FIG. 1 is a sectional view showing a schematic configuration of a catalyst body 100 according to an embodiment of the present invention.

The catalyst body 100 is composed of a porous support 10 made of inorganic materials, single crystals 20 of zeorite, and a catalyst 30. The porous support 10 is a structure body having plural fine pores or plural fine holes on the surface thereof, for example, made of cordierite. The plural fine pores are omitted from FIG. 1, but schematically designated by dotted-hatching. In the embodiment, the cordierite is used as the porous support 10.

On the surface of the porous support 10, at least one type of the single crystals 20 made of zeorite are directly grown using a component element of the porous support 10 as a seed crystal for the single crystal.

FIG. 1 schematically shows a plurality of the zeolite single crystals 20 of a rectangle prism shape grown on the surface of the porous support 10.

The single crystal 20 of zeolite is alumino-silicate. In practice, each single crystal 20 of zeolite is made of one or more compounds selected from CeO₂, ZrO₂, Al₂O₃, TiO₂, SiO₂, MgO, and derivatives of those elements. At least one of them is grown as the single crystals 20 on the surface of the porous support 10.

In particular, it is preferred that the catalyst capable of purifying automobile exhaust gas is composed of one or more compounds selected from Al₂O₃, SiO₂ and a derivatives of Al₂O₃, SiO₂.

On the porous support 10 according to the embodiment, each single crystal 20 of zeolite is grown based on a seed crystal of Al₂O₃ or SiO₂ that is a main component of the cordierite.

It is still further preferred to use ZSM-5 as zeolite in the embodiment. ZSM-5 is a typical high-silica synthetic zeolite having a unit cell composition of Nan [Aln Si₉₆-nO₁₉₂]. xH₂O that has been widely known as MFI type of construction code of zeolite.

In general, ZSM-5 increases its hydrophobic property according to decreasing of aluminum (Al) concentration. ZSM-5 having no Al is called “silicalite”. This silicalite has a high hydrophobic property and has a three-dimensional (3D) fine pores by which a chemical reaction occurs on using it as catalyst.

Each fine pore of silicalite is slightly larger in dimension than benzene and a specific selecting characteristic in a catalyst reaction with aromatic hydrocarbon. Thus, because silicalite has the molecular selecting function based on its fine pore and has a strong solid-acid property, silicalite has been well known as a shape selecting catalyst. Further, because of the highly hydrophobic property, silicalite can absorb selectively organic materials dissolved in water. Silicalite is capable of purifying atmosphere and applicable to environmental purifying field.

Still further, silicalite has a superior thermal resistance, a superior acid resistance, and a high acid property. By the way, although mordenite has been known as zeolite having a highly thermal resistance material, mordenite has a thermal resistance only up to 800° C. On the contrary, silicalite has the thermal resistance up to 1000° C. and stable at approximately 1000° C.

The single crystal 20 of zeolite according to the embodiment is grown using the component of the porous support 10 made of cordierite as a seed crystal, and the single crystal 20 of zeolite is strongly adhered on and fixed to the porous support 10. Further, the adhesion state of the single crystal 20 of zeolite does not close or cover the fine pores of cordierite. In other word, the presence of the single crystals 20 of zeolite does not deteriorate the specific property of the porous support 10 as cordierite monolith.

There is no limitation how to grow the single crystals 20 of zeolite on the cordierite porous support 10 in the embodiment, hydrothermal method is preferred. In the hydrothermal method, a slurry solution composed of raw materials of zeolite and cordierite porous support 10 are put in a pressure vessel and reacted therein.

In the hydrothermal method, a specified amount of a raw element (for example, SiO₂) as a construction material to be synthesized, a template element by which fine pores (which are one feature of zeolite) are formed, and pure water are put in a pressure vessel. The porous support 10 of cordierite is then immersed in the above solution, and the hydrothermal synthesis process is performed.

Zeolite is thereby grown on the porous support 10 as a seed crystal and the single crystals 20 are grown using the raw material of zeolite. It is thereby possible to strongly grow the single crystals 20 of zeolite directly on the porous support 10.

In addition, it is acceptable to grow the single crystals 20 of zeolite on the entire surface of the porous support 10. However, the present invention is not limited by this configuration. For example, it is possible to grow the single crystals 20 of zeolite only at the upstream part or the downstream part on the surface of the porous support 10 when the catalyst body 100 of the embodiment would be used as an exhaust purifying apparatus through which an exhaust gas emitted from an internal combustion engine flows.

The catalyst 30 is scattered and supported by the single crystals 20 of zeolite. FIG. 1 schematically shows each catalyst 30 of a cylindrical shape designated by slant lines or hatching.

It is preferred and also acceptable that the catalyst 30 is composed of a layer of several atomic scale or composed of less than 3 nm grain diameter (or grain size).

Concrete examples of such catalyst 30 include one or more of noble metals selected from Pt, Rh, Pg, Au, Ag, Ru, Ir, Os, and a noble metal oxide of the above noble metal, and a solid solution made of more than the above-described two noble metals.

A more concrete example of the catalyst 30 for use in automobile exhaust gas purifying includes a first element and a second element or a complex body of the first and second elements, where the first element is a promoter catalyst component capable of absorbing, accumulating, and discharging oxygen, and the second element is a noble metal component.

In an example of such a complex body, a base particle and a catalyst particle are the first element and the second element, respectively, where the base particle is made of a single fine particle of a primary grain diameter of a nm (nanometer) order or more than two kinds of compound fine particle, and the catalyst particle is made of more than one noble metal or a noble metal oxide that cover at least a part of the surface of the base particle. Japanese patent laid open publication number JP2003-80077 has disclosed such a catalyst particle.

The catalyst 30 having the above configuration can be made by a method of simultaneous vaporization, coprecipitation, sol-gel manner, plating, ultra-sonic assist reduction method, and the like. In the ultra-sonic assist reduction method, a base particle and a metal precusor are dissolved in a solution so as to make a mixed solution, and ultrasonic is irradiated into the mixed solution so that a coating layer of nanometer order metal fine particles or a layer of several-atomic scale are precipitated by performing reduction of the metal precusor.

The first element is CeO₂/ZrO₂ solid solution, and the second element is a noble metal selected from Pt, Rh, Pd, Ru, Ir, Os, Au, Ag, an alloy of those noble metals, its oxide, and a complex oxides. Further, the first element has a grain diameter of not more than 3 nm to 5 nm, preferably, of not more than 10 nm, and the second element has a grain diameter of not less than 10 nm, more preferably, of not more than 1 nm.

Although the present invention does not limit the supporting manner of supporting the catalyst 30, an impregnation method is a preferable supporting technique, which directly impregnates the porous support 10 on which the single crystals 20 of zeolite are grown into a slury solution made of the catalyst 30 after firing and eliminating a template material in fine pores of zeolite. This impregnation method is a superior manner in order to easily perform a uniform coating. There is an ion-exchange method as another supporting technique, in which cordierite monolith base with silicalite is immersed into the above solution in which the catalyst components are scattered, and the solution is placed in a low constant temperature dryer apparatus while mixing the solution by a stirrer for four days.

By the way, as described above, the catalyst particles to be used as automobile exhaust gas purifying catalyst at a high temperature of approximate 1000° C. In such a high temperature condition, sintering occurs and catalyst particles thereby move and combine together by high temperature thermal energy. This phenomenon causes a problem of increasing non-active surface area and deteriorating its purifying property.

In the catalyst body 100 of the embodiment according to the present invention, because the single crystals 20 of zeolite are grown directly on the surface of the porous support 10 from a seed crystal made of the component element forming the porous support 10, the single crystal 20 of zeolite is directly grown on the surface of the porous support 10.

As shown in FIG. 1, the catalyst 30 is supported by the single crystals 20 of zeolite, and this configuration is capable of preventing the occurrence of sintering the catalyst because a strong barrier is formed between the catalysts 30 and this configuration can prevent a combination of the particles of the catalyst 30 to each other when compared with a conventional case in which catalysts are supported by alumina.

When compared with alumina powders causing that catalyst components are embedded in the alumina particles by deformation of γ-alumina, the single crystals 20 of zeolite grown on the surface of porous support 10 of the embodiment has a superior property of thermal resistance.

According to the embodiment of the present invention, because the minimum necessary-amount of the catalyst can be used without supporting an excess (or un-necessary) amount of catalyst component, the total amount of the catalyst component can be reduced. Because this feature further reduces the flow resistance and the thermal capacity of the catalyst body and the inorganic support, it is possible to achieve the protection of environment and to reduce the total manufacturing cost of the catalyst body, the inorganic support, and various applications using them.

Still further, because the produced single crystals 20 of zeolite are capable of absorbing gas, it can absorb hydro carbon (HC) gas. This is effective in the reduction of vehicle hydro carbon (HC) gas in the atmosphere emitted from an internal combustion engine mounted on a vehicle. In particular, when applied to a diesel car, the inorganic support, the catalyst body according to the embodiment can absorb particulate matter (PM) of approximately 250° C. exhausted from a diesel engine and the activated catalysts can purify those PM.

Still further, according to the embodiment of the present invention, because the single crystals 20 of zeolite are grown directly on the surface of the porous support 10 and do not close the fine pores formed on the porous support 10, the catalyst body and the inorganic support can maintain its superior thermal resistance property.

Although a detailed mechanism of increasing the combining force between the catalyst 30 and SiO₂ has not been analyzed, the combining force of the catalyst 30 and SiO₂ are both enhanced when SiO₂ is used as a raw material of zeolite. This composition can suppress the deterioration of the catalyst property caused by cohesion and the like after long use at high temperatures, and is thereby possible to maintain its catalyst property of high activation.

As a concrete example of the combination of the single crystal 20 of zeolite and the catalyst 30, there are a combination of CeO₂ fine particles and zeolite involving SiO₂ raw material and a combination of CeO₂-ZrO₂ solid solution fine particles and zeolite involving SiO₂ raw material.

On using SiO₂ raw material in zeolite, it is possible to produce a catalyst capable of purifying vehicle exhaust gas with a thermal resistance and high durability.

The inorganic support of the embodiment according to the present invention is a composition made of the single crystal 20 of zeolite directly grown on the surface of the porous support 10, that is, the inorganic support of the embodiment has the composition obtained by eliminating the catalyst 30 from the catalyst body 100 of the embodiment of the present invention. The action and effect of the inorganic support of the embodiment described above can be achieved when catalyst is supported on the inorganic support.

Hereinafter, an example of the inorganic support and the catalyst body 100 of the embodiment according to the present invention will be explained. However, the concept of the present invention is not limited by the following example. It is acceptable to apply the concept of the present invention to various applications such as an exhaust gas purifying technique field, an environmental purifying field, and a fuel cell field, in which the catalyst 30 such as noble metal is supported on the porous support 10 as a cordierite monolith base on which the single crystal 20 of zeolite is grown.

### CONCRETE EXAMPLE

### (Inorganic Support)

A cordierite monolith is used as the porous support 10 of the embodiment according to the present invention.

FIG. 2 is a flow chart showing a method of producing the inorganic support of the embodiment according to the present invention.

First, the cordierite monolith is prepared as the porous support. This cordierite monolith has a dimension of φ=30 mm diameter and 25 mm length. Tetrapropylammonium bromide (TPABr) is weighted as a template agent in a molar ratio of SiO₂: TPABr: H₂O=1 : 0.125: 66 or of SiO₂: TPABr: H₂O=1 : 0.48: 48. TPABr is dissolved into ion-exchanged distilled water. At this time, this solution is adequately dissolved using an ultrasonoic disperter. (Step S21).

The solution involving TPABr is transferred into a pressure-thermal resistance vessel in which the cordierite monolith has been put in advance while filtering the above solution through a membrane filter having 0.2 μm diameter in order to eliminate impurities from the solution. The pressure-thermal resistance vessel is placed into an autoclave made of stainless steel and closed completely without any leakage. (Step S22)

The autoclave is placed in a forced circulation electric dryer. Crystalization is then performed at a temperature range of 150° C. to 220° C. for desired hours of a range of 24 hours to 336 hours. After this, the autoclave is taken out from the forced circulation electric dryer, and then gradually cooled at a room temperature. The content in the autoclave is adequately washed by ion-exchanged distilled water, and then dried at a temperature of 150° C. for one hour in order to obtain the inorganic support according to the embodiment of the present invention in which the silicalite single crystals as zeolite composed mainly of silica raw material are grown directly on the porous support 10 made of cordierite monolith. (Step S23)

### (Catalyst)

Next, a description will now be given of the method of preparing the catalyst based on ultrasonic assist reduction manner.

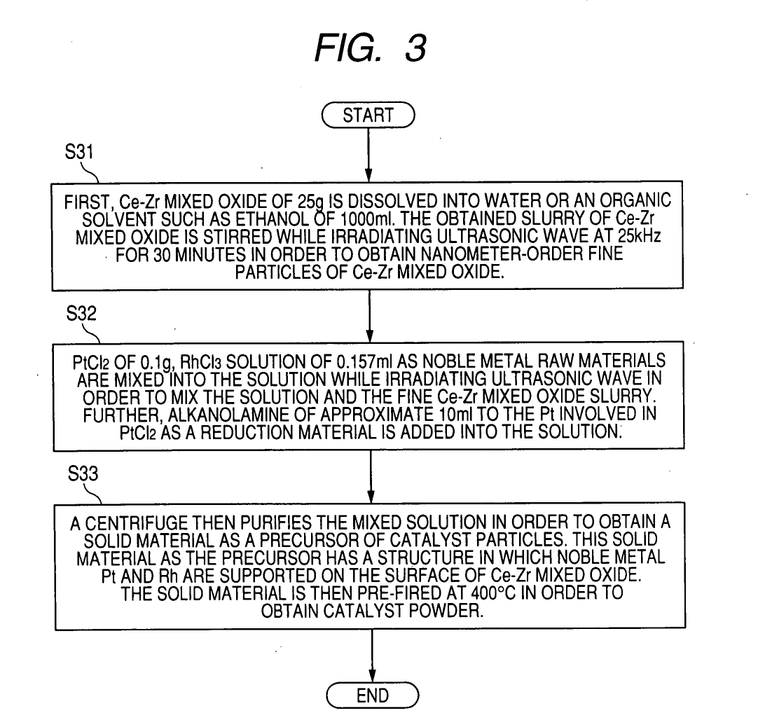

FIG. 3 is a flow chart showing a method of producing the catalyst to be used for forming the catalyst body 100 of the embodiment according to the present invention.

First, Ce-Zr mixed oxide of 25 g is dissolved into water or an organic solvent such as ethanol of 1000 ml. The obtained slurry of Ce-Zr mixed oxide is stirred while irradiating ultrasonic wave at 25 kHz for 30 minutes in order to obtain nanometer-order fine particles of Ce-Zr mixed oxide. (Step S31)

Then, PtCl₂ of 0.1 g, RhCl₃ solution of 0.157 ml as noble metal raw materials are mixed into the above solution while irradiating ultrasonic wave in order to mix the solution and the fine Ce-Zr mixed oxide slurry. Further, an alkanolamine of approximate 10 ml to the Pt involved in PtCl₂ as a reduction material is added into the solution. (Step S32)

The above steps can be performed using a sonoreacter in which a vessel involving the above solution involving the mixed raw materials is placed. This reduction reduces produces platinum chloride PtCl₂ and rhodium chlorite RhCl₃ in order to produce Pt particles and Rh particles.

A centrifuge then purifies the mixed solution obtained by the above manner in order to obtain a solid material as a precursor of catalyst particles. This solid material as the precursor has a structure in which noble metal Pt and Rh are supported on the surface of Ce-Zr mixed oxide. After this, the solid material is pre-fired at 400° C. in order to obtain catalyst powder. (Step S33)

The solid material obtained by the above manner is dispersed into water or organic solvent in order to prepare a dispersed solution.

It is acceptable to prepare slurry capable of easily supporting the noble metal onto the cordierite monolith base by adjusting pH of the dispersed solution by adding nitric acid and the like into the dispersed solution. As another manner, it is acceptable to prepare a slurry capable of easily supporting the noble metal onto the cordierite monolith base by using a mixer, a homogenizer, an agitation mill, and the like.

Next, ultrasonic wave is irradiated again at 25 kHz into the dispersed solution involving the catalyst components in order to obtain the dispersed solution involving fine particles of the catalyst in nanometer order.

### (Catalyst Body)

Next, a description will now be given of the supporting manner of supporting the catalyst component on the cordierite monolith base (hereinafter, referred to as “cordierite monolith base with silicalite”) on which the single crystals of silicalite are grown.

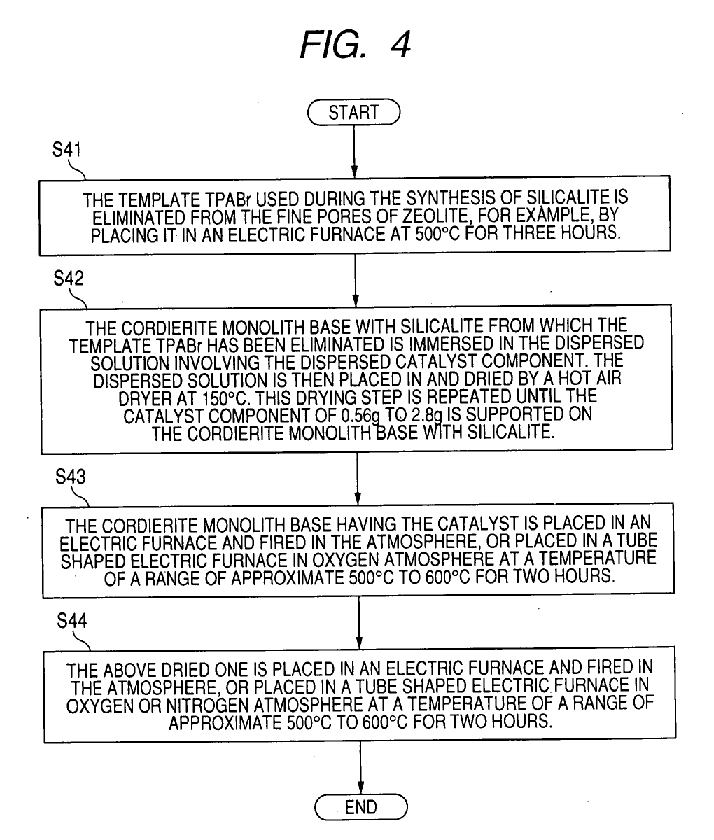

FIG. 4 is a flow chart showing a method of producing the catalyst body of the embodiment according to the present invention.

First, the template TPABr used during the synthesis of silicalite is eliminated from the fine pores of zeolite. For example, it is possible to eliminate the template TPABr from the fine pores of zeolite by placing it in an electric furnace at 500° C. for three hours. (Step S41)

Following, the cordierite monolith base with silicalite from which the template TPABr has been eliminated is immersed in the dispersed solution involving the dispersed catalyst component. This dispersed solution is then placed in and dried by a hot air dryer at 150° C. This drying step is repeated until the catalyst component of 0.56 g to 2.8 g is supported on the cordierite monolith base with silicalite. (Step S42)

After this step, the cordierite monolith base having the catalyst is placed in an electric furnace and fired in the atmosphere, or placed in a tube shaped electric furnace in oxygen atmosphere at a temperature of a range of approximate 500° C. to 600° C. for two hours. (Step S43)

The concept of the present invention is not limited by the above step. For example, it is possible to use ion-exchange manner as another catalyst supporting manner. In the ion-exchange manner, the cordierite monolith base with silicalite is immersed in the catalyst dispersed solution described above, and this solution is placed in a low constant temperature dryer apparatus for four days while mixing it by a stirrer. After this step, the solution is filtered and washed by pure water, and dried.

Finally, the above dried one is placed in an electric furnace and fired in the atmosphere, or placed in a tube shaped electric furnace in oxygen or nitrogen atmosphere at a temperature of a range of approximate 500° C. to 600° C. for two hours. The production of the catalyst body 100 of the embodiment is thereby completed. (Step S44)

The embodiment of the present invention described above provides the catalyst body of the superior thermal resistance and absorption property capable of absorbing hydro carbon (HC) and particulate matters (PM), and the catalyst body of the embodiment is applicable to exhaust gas purifying, for example. In the catalyst body, the catalyst components are dispersed on the surface of the cordierite monolith base with silicalite.

The present invention is not limited by the above described embodiment disclosing the manners and concrete examples. It is acceptable to have another raw material and shape of the catalyst body unless at least one kind of single crystal of zeorite is grown directly on the porous support made of inorganic materials in which the component element of the porous support is used as a seed crystal for the single crystal, or unless the single crystals of zeolite grown on the inorganic support the catalyst.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A catalyst body comprising:
a porous support made of inorganic materials;
single crystals of at least one kind of zeolite directly grown on a surface of the porous support, using a component element forming the porous support as a seed crystal of each single crystal of zeolite; and
catalysts supported on the single crystals of zeolite.

2. The catalyst body according to claim 1, wherein the porous support is made of cordierite, and each single crystal is grown using the seed crystal made of Al₂O₃, SiO₂ that are main component elements of the cordierite.

3. The catalyst body according to claim 1, wherein each single crystal of zeolite is grown by one or more compounds selected from a group of Al₂O₃, SiO₂, and derivatives of Al₂O₃, SiO₂.

4. The catalyst body according to claim 2, wherein each single crystal of zeolite is grown by one or more compounds selected from a group of Al₂O₃, SiO₂, and derivatives of Al₂O₃, SiO₂.

5. An inorganic support comprising:
a porous support made of inorganic materials; and
single crystals of at least one kind of zeolite directly grown on a surface of the porous support, using a component element forming the porous support as a seed crystal of each single crystal of zeolite.

6. The inorganic support according to claim 5, wherein the porous support is made of cordierite, and each single crystal is grown using the seed crystal made of Al₂O₃, SiO₂ that are main component elements of the cordierite.

7. The inorganic support according to claim 5, wherein each single crystal of zeolite is grown by one or more compounds selected from a group of Al₂O₃, SiO₂, and derivatives of Al₂O₃, SiO₂.

8. The inorganic support according to claim 6, wherein each single crystal of zeolite is grown by one or more compounds selected from a group of Al₂O₃, SiO₂, and derivatives of Al₂O₃, SiO₂.

9. A method of producing the inorganic support according to claim 5, comprising steps of:
immersing the porous support made of inorganic materials into an aqueous solution in which raw materials of single crystals of zeolite are mixed;
performing hydrothermal manner for the aqueous solution involving the porous support and the raw materials.

10. The method of producing the inorganic support according to claim 5, wherein the porous support is made of cordierite monolith, and the hydrothermal manner is performed using a forced circulation electric dryer into which cordierite monolith, tetrapropylammonium bromide (TPABr) as a template agent, and pure water are placed and kept at a temperature of a range of 150° C. to 220° C. for a time period of 24 hours to 336 hours in order to grow the single crystals of zeorite directly on the surface of the porous support.
